(19) United States
(12) Patent Application Publication
(10) Pub. No.: US 2025/0363271 A1
(43) Pub. Date: Nov. 27, 2025

(54) SYSTEM DESIGN OPTIMIZATION SYSTEM AND METHOD

(71) Applicant: HITACHI, LTD., Tokyo (JP)

(72) Inventors: Jayesh Ravindra Guntupalli, Tokyo (JP); Kentaro Watanabe, Tokyo (JP)

(73) Assignee: HITACHI, LTD., Tokyo (JP)

(21) Appl. No.: 19/088,630

(22) Filed: Mar. 24, 2025

(30) Foreign Application Priority Data
May 23, 2024 (JP) 2024-084407

(51) Int. Cl. G06F 30/27; G06F 111/04

(52) U.S. Cl. CPC G06F 30/27; G06F 2111/04

(57) ABSTRACT

A system design optimization system that optimizes design of a target system is configured to acquire feedback related to an improvement of the target system from a stakeholder of the target system, interpret the acquired feedback to apply the feedback to the target system, generate, from a result of the interpretation, an instruction set to be given to the target system, provide the stakeholder with an implementation status of the instruction set, and acquire the feedback related to the improvement of the target system until the stakeholder approves.

### BACKGROUND

The present disclosure relates to a system and method for system design optimization.

The field of system design optimization has conventionally relied on computational models for automating and enhancing a decision-making process. In a conventional system design approach, throughout an entire design process, there is no continuous monitoring by experts, such as system engineers. This has been a significant constraint on optimization of a complicated target system where complex dependencies and performance requirements are present.

As a system optimization approach, a technology including Approximate Bayesian Monte Carlo Tree Search (ABMCTS) has been known (US Patent Application Publication No. 2023/0088146). This related art technology attempts to automatically optimize design parameters through a sophisticated algorithmic approach.

### SUMMARY

However, the related art technology has following problems.

First, due to a lack of direct integration of human expertise with feedback to the target system, nuanced insights may be missed.

Second, it may not be possible to successfully cope with unexpected design requirements or changes that are not anticipated in an initial model.

Third, to perform an iterative search and an optimization process, reliance is heavily placed on computational sources. Therefore, it may be inefficient when the target system is complicated.

Fourth, an algorithm may converge on local optima. Consequently, a potentially better solution that requires a more fundamental design change may be missed.

Additionally, in the related art technology, timely and detailed feedback from an important stakeholder, such as a designer or an administrator of the target system, has not been incorporated as a function, and therefore it is difficult for design of the target system to fulfill real needs. The related art technology normally cannot adjust system design on the basis of new requirements and feedback, and therefore, it may be possible that efficient system design cannot be performed, thereby resulting in a longer development period.

The present disclosure has been made in view of the problems described above, and an object thereof is to provide a system and method for system design optimization that can efficiently optimize design of a target system.

To solve the problems described above, a system design optimization system according to an aspect of the present disclosure is a system design optimization system that optimizes design of a target system, the system design optimization system being configured to: acquire feedback related to an improvement of the target system from a stakeholder of the target system; interpret the acquired feedback to apply the feedback to the target system; generate, from a result of the interpretation, an instruction set to be given to the target system; provide the stakeholder with an implementation status of the instruction set; and acquire the feedback related to the improvement of the target system until the stakeholder approves.

According to the present disclosure, it is possible to acquire the feedback related to the improvement of the target system from the stakeholder, apply the feedback to the target system, and iteratively execute the feedback until an approval is obtained from the stakeholder, and it is possible to efficiently and appropriately improve the target system.

### BRIEF DESCRIPTION OF THE DRAWINGS

FIG. 1 is an illustrative view illustrating an overall configuration of a system optimization system;

FIG. 2 is a flow chart illustrating an overall flow in the system optimization system;

FIG. 3 is a diagram illustrating a method of producing each table;

FIG. 4 is a flow chart illustrating processing to be performed by a feedback interpretation module (FIM);

FIG. 5 is a flow chart illustrating processing to be performed by a contextual feedback integration mechanism (CFIM);

FIG. 6 is a flow chart illustrating processing to be performed by a design reinforcement engine (DRE);

FIG. 7 illustrates an example of a structured instruction table;

FIG. 8 illustrates an example of an actionable change instruction table;

FIG. 9 illustrates an example of an integration plan table;

FIG. 10 illustrates an example of an action space table; and

FIG. 11 illustrates an example of a state space table.

### DETAILED DESCRIPTION OF THE EMBODIMENT

The following will describe an embodiment of the present disclosure on the basis of the drawings. The following description and the drawings are illustrative examples for explaining the present disclosure, and are omitted and simplified as appropriate for clarity of the explanation. The present disclosure can also be implemented in various other forms. Unless otherwise particularly limited, each of components may be either singular or plural.

For easier understanding of the invention, a position, size, shape, range, and the like of each of the components illustrated in the drawings may not represent an actual position, size, shape, range, and the like thereof. The present disclosure is not necessarily limited to the position, size, shape, range, and the like disclosed in the drawings.

In the following description, various information may be described by using such expressions as “database”, “table”, and “list”, but the various information may also be expressed by data structures other than these. In order to show no dependency on the data structures, an “XX table”, an “XX list”, and the like may be referred to also as “XX information”. When a description will be given of identification information, in a case of using such expressions as “identification information”, “identifier”, “name”, “ID”, and “number”, these are replaceable with each other.

When there are a plurality of components having the same or similar functions, a description will be given thereof by adding different additional characters to the same reference signs. However, where there is no need to distinguish these plurality of components from each other, a description may be given by omitting the additional characters.

In the following, processing to be performed by executing a computer program may be described but, since the computer program is executed by a processor (e.g., CPU (Central Processing Unit) or a GPU (Graphics Processing Unit)) to perform determined processing, while appropriately using a storage resource (e.g., memory) and/or an interface device (e.g., communication port) or the like, a subject of the processing may also be the processor. Likewise, the subject of the processing to be performed by executing the computer program may also be a controller, an apparatus, a system, a computer, or a node having the processor. The subject of the processing to be performed by executing the computer program needs only to be an arithmetic operation unit, and may also include a dedicated circuit (e.g., FPGA (Field-Programmable Gate Array) or ASIC (Application Specific Integrated Circuit)) that performs specific processing.

The computer program may also be installed to an apparatus, such as a computer, from a program source. The program source may also be, e.g., a computer program distribution server or computer-readable storage medium. When the program source is the program distribution server, it may also be possible that the program distribution server includes a processor and a storage resource that stores a program to be distributed, and the processor of the program distribution server distributes the program to be distributed to another computer. In addition, in the following description, two or more programs may be implemented as one program, or one program may also be implemented as two or more programs.

The present disclosure relates to a technology of optimizing system design. The present disclosure relates to a method of using feedback from a stakeholder to iteratively improve a design draft of a target system. A system design optimization system in the present disclosure utilizes an approach based on Reinforcement Learning (RL) to incorporate expertise of system engineers directly into a design process for optimizing the target system. Thus, the system design optimization system in the present disclosure automatically learns from the feedback from an expert, such as the system engineer, and iteratively evolves the system design.

It is to be noted herein that, in the present disclosure, the target system may be of any type. Any type of information processing system may be the target system. A method in the present disclosure can continue to iteratively improve a financial processing system, an inventory management system, a video distribution system, an electronic commerce system, an image processing system, a file sharing system, a business assistance system, a learning assistance system, a drag development system, a railway management system, a power generation control system, a factory production management system, and the like.

The present disclosure recognizes an important role of knowledge of the system engineers in management of the design process, and suggests a solution described later. In addition, the present disclosure effectively uses valuable inputs (feedback) from not only the system engineers, but also the stakeholders including the system engineers. The stakeholders mentioned in the present specification are people who contribute to the iterative improvement of the target system. Examples of the stakeholders include a technical expert (system engineer) for the target system, a technical consultant related to the improvement of the target system, an administrator of the target system, a user of the target system, and the like.

In general, the system engineers have knowledge and experience capable of improving a design quality and adequacy of the target system in the design process. However, manually updating design on the basis of the feedback is rather tedious work and, as the target system is more complicated, the work is more difficult.

Therefore, the present disclosure introduces a new RL-based approach of learning from the feedback given by the system engineers. This method can train an algorithm to make better design choices, and can match the design of the target system gradually to an intended goal. A RL component serving as a “reinforcement learning unit” uses a set of “actionable change instructions” produced from previous feedback analysis and integration to select an optimal “design update instruction”. This selection process, including the expert opinion of the system engineers in an automated design improvement process, helps ensure that each design update brings the target system closer to a configured goal.

Thus, the system design optimization system in the present disclosure is improved over the related art technology, and iteratively and effectively improves the system design. The system design optimization system in the present disclosure can save time and labor, while improving an ability to adapt to changing needs and expert advice to the target system.

As described above, the invention described herein uses the feedback from the stakeholders to improve the design of the target system through the process of incorporating the expertise of the system engineers directly into an automated design refinement process. This method uses advanced natural language processing (NLP), machine learning, and reinforcement learning (RL) technology to transform the feedback from the stakeholders to specific and actionable changes in the design of the target system.

The process in the present disclosure begins in a feedback interpretation module (FIM). The FIM receives detailed technical specifications and the feedback from the stakeholders (including the system engineers) via a structured interface. The FIM analyzes these inputs to identify and quantify desirable system performance changes, such as processing speed and latency. These changes made by the FIM are then prioritized on the basis of design goals of the target system and potential effects on performance of the entire target system.

A Contextual Feedback Integration Mechanism (CFIM) receives the structured and prioritized feedback from the FIM, and applies the feedback to a specific one of the individual system components included in the target system.

The CFIM performs a detailed analysis to check how suggested changes will affect other portions of the target system. The CFIM checks the suggested changes against current abilities of the target system to confirm that these changes are actionable. Then, the CFIM produces detailed actionable change instructions, and produces a plan indicating a best method to implement these changes.

These instructions are sent to a Design Reinforcement Engine (DRE), which uses the RL technology to select a most effective design update. The DRE has a clear reward function to evaluate success of different design changes, and refines an approach through several rounds to select an action that most improves the design. With a lapse of time, the DRE learns from effects of the changes implemented thereby, and continuously improves the design, while reflecting decisions made by the system engineers, who are the stakeholders. The DRE selects “Design Update Instructions” that are highly likely to bring about desirable improvements within the constraints and requirements of the target system.

Since the DRE uses results of previous updates and the continuous feedback from the stakeholders to continue to improve the design, this iterative process allows continuous learning and adjustment to be performed. As a result, the design of the target system is continuously improved, while benefiting from both efficiency of machine learning and human expertise. This improvement process is dynamic, and adapts in real time to changes in system requirements and the feedback from the stakeholders. Therefore, the design of the target system remains flexible and aligned with the goal of the project aiming at the improvement of the target system.

As a whole, the present disclosure responds to the feedback from the stakeholders and provides a strong framework for iteratively improving the system design (design of the target system) on the basis of practical realities of an operational status of the target system. This is an important advance in the field of the automated system design optimization, which leads to higher efficiency, a shorter development period, and better alignment between user needs and system performance goals.

### First Embodiment

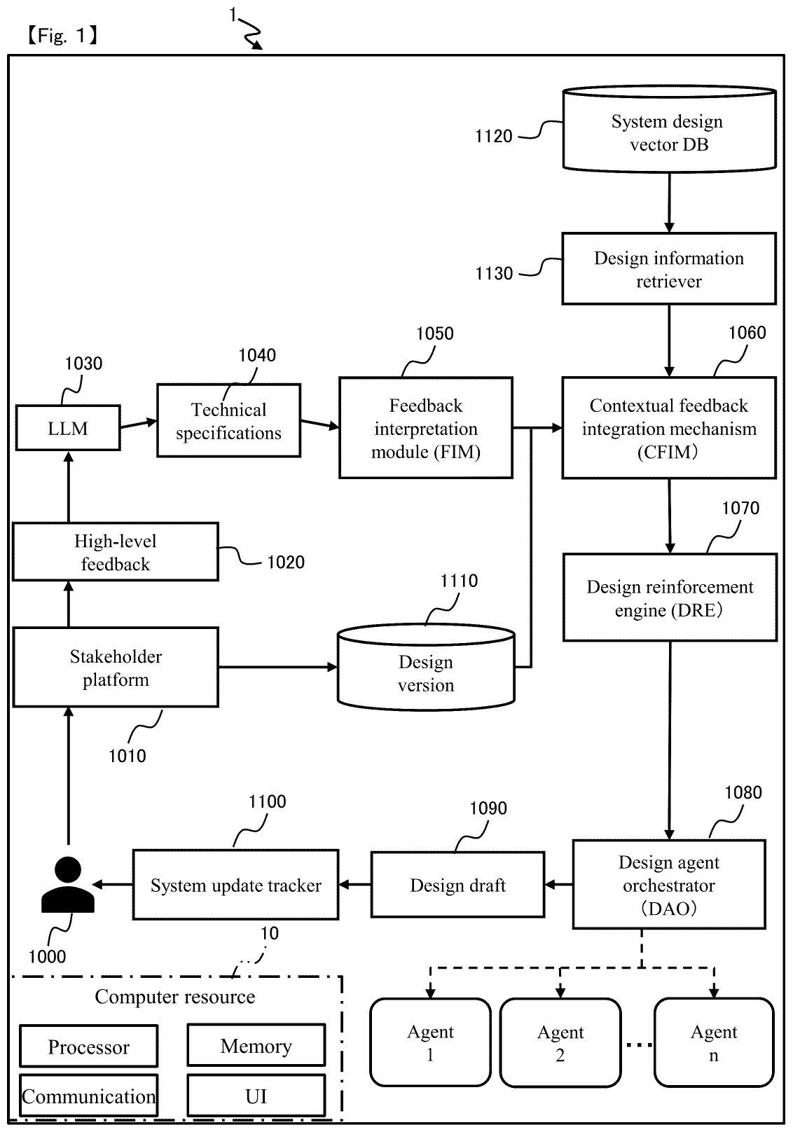

Referring to FIG. 1 to FIG. 11, Embodiment 1 will be described. The following will refer to a system targeted by a system design optimization system 1 as the “target system” or “system”. In FIG. 1, the target system has no reference sign, but design information of the target system is stored in a system design vector database 1120. As described above, the target system to be iteratively improved by the system design optimization system 1 is of any type. In the drawings, the database may be abbreviated as DB.

The system design optimization system 1 is generated by using a computer resource 10 included in the computer. Examples of the computer resource 10 include a processor, memories, a communication unit, a user interface (UI), and the like. The memories include a main storage apparatus and an auxiliary storage apparatus. The memories may further include a storage medium detachable from the computer. On the storage medium, a computer program for implementing some or all of functions of the system design optimization system 1 can non-temporarily be stored.

The following is a definition of the feedback in the present specification. The feedback in the present specification includes various types of information for iteratively improving the system design. The feedback comes from observation, knowledge, and instructions of the stakeholders (including the system engineers) to show deep understanding of what is needed by the target system and what is needed by end users. The feedback functions as data that drives continuous enhancement of the system design, and guides each new round of updates. However, the foregoing description is illustrative examples, and the feedback is not limited to the description given above. The feedback mentioned in the present specification is not limited thereto.

System Requirements: System requirements are detailed technical and functional specifications that describe the goals of the target system. For examples, there are numerical specifications such that “the system should process a transaction within 2 seconds” or quality-related specifications such that “the system should have an intuitive user interface”.

Customer Needs: Customer needs include ease of use of the target system, reliability thereof, performance expected therefrom, and other elements that affect user satisfaction and the ease of use of the system.

Requirement Update Feedback: Requirement update feedback is information for adjusting the specifications of the target system on the basis of new discoveries, technological advances, or changing needs of the end users. This keeps the design of the target system up-to-date and can satisfy goals of the stakeholders.

Design Update Feedback: Design update feedback is suggestions or required changes to the current design which are prompted by a test result, feedback from users as the stakeholders, or updates needed for compliance. These changes help maintain the functionality and performance of the target system in appropriate states.

Specification Update Feedback: Specification update feedback is to continuously update documents of the target system in order to reflect a latest design change. The specification update feedback is information for confirming that the stakeholders have latest information related to functions of the target system and reasons behind the design.

In the present specification, the feedback is an important starting point from which the design of the target system is constantly evaluated and enhanced. The feedback is regarded as a strategic resource that guides decision-making throughout the entire design process, from an initial concept to final deployment and beyond.

Importance of Feedback from System Engineers in Design Automation Process: The feedback from the system engineers as the stakeholders offer a perspective on complicated details of the design of the target system. The system engineers with extensive technical knowledge and practical experience provide feedback which ensures that the design is both technically robust and effectively meets the needs of the end users.

In the process of iteratively optimizing the system design in the present disclosure, the feedback from the system engineers is important for the following reasons.

This functions as a quality control measure which adds a human element for checking and confirming automated design determination.

This gives expert knowledge that helps identify a subtle and complicated problem that may be missed or misinterpreted by an automated system

This introduces real-world insights such that theoretical design effectively functions in a practical situation.

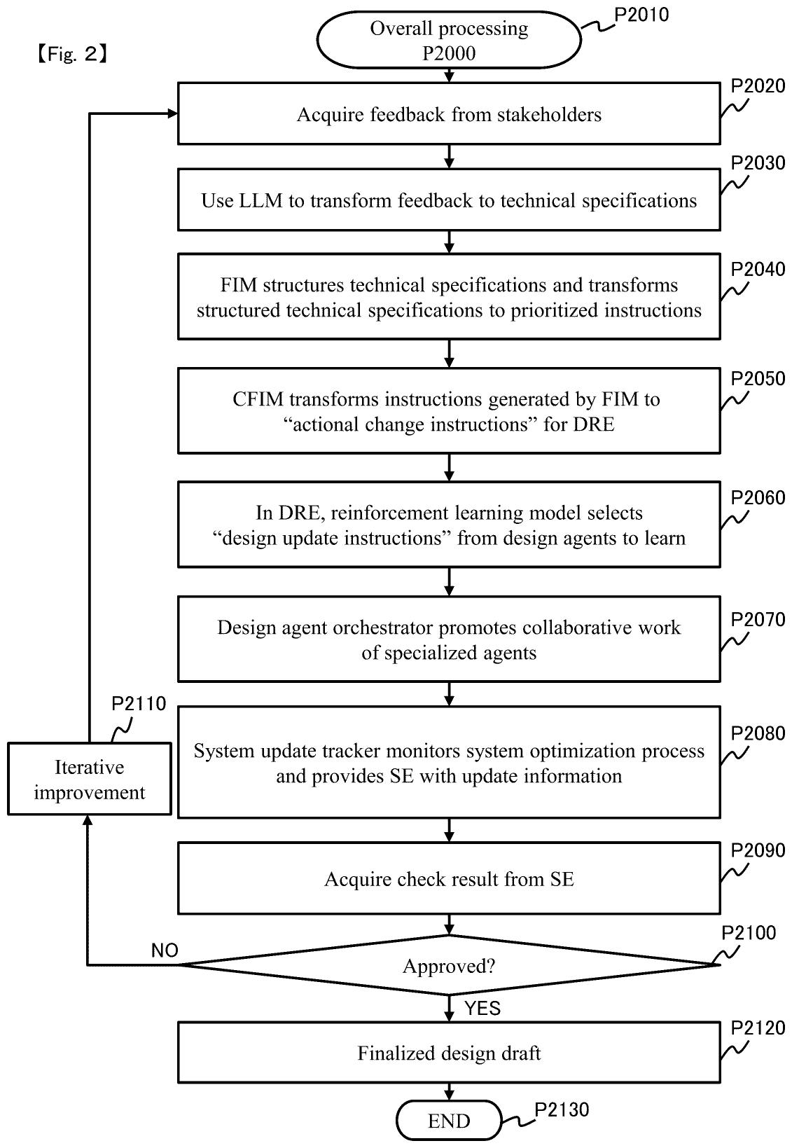

When changes for the target system are suggested, the feedback from the system engineers places these changes in a larger operational status of the target system to prevent these changes from unintentionally causing new problems or degrading the performance of the target system. In the present disclosure, through a feedback information iterative process involving the stakeholders including the system engineers, the system design is optimized. In the system design optimization system 1, a set of advanced technological components that work together to improve the design according to both the technical specifications and nuanced needs of the users are incorporated. As illustrated in FIG. 1 and FIG. 2, the following will clarify structures and functions of these components, and describe a workflow leading to optimized system design.

### Overview of System

Referring to FIG. 1, the system design optimization system 1 includes a stakeholder platform 1010, a large-scale language model (LLM) 1030, a feedback interpretation module (FIM) 1050, a contextual feedback integration mechanism 1060, a design reinforcement engine (DRE) 1070, a design agent orchestrator 1080, a system update tracker 1100, a system design vector database 1120, and a design information retriever 1130, which will be individually described later.

A system design optimization process begins with inputting of high-level feedback 1020 to the stakeholder platform 1010 by any of stakeholders 1000 including the system engineers. The stakeholder platform 1010 serving as a “feedback reception unit” functions as a first collection point for the feedback. This feedback includes broad conceptual ideas or specific technical instructions. The high-level feedback 1020 is transferred to the large-scale language model (LLM) 1030, which is a sophisticated algorithm capable of processing complicated inputs and generating detailed technical specifications 1040. These specifications serve as a basis for further design iteration. The LLM 1030 is an example of a “large-scale language model unit”.

These technical specifications 1040 are processed by the feedback interpretation module (FIM) 1050, which is a main component in charge of decomposing and analyzing the technical specifications. The FIM 1050 serving as the “feedback interpretation module” segments and classifies the technical specifications by using advanced natural language processing to extract specific performance indices from the technical specifications 1040 and understand the extracted performance indices. The FIM ensures that nuances of a language used in the technical specifications are correctly interpreted and that a set of structured and prioritized actionable instructions is obtained.

The structured output from the FIM is then transferred to the contextual feedback integration mechanism (CFIM) 1060 serving as the “contextual feedback integration mechanism”. The function of the CFIM 1060 is to contextually map the feedback to the design elements and components of the target system. The mapping specifies where and how the feedback should be applied within the current system set-up and pinpoints specific components to which the feedback corresponds, such as a CPU, a database, network set-up, or an algorithm. The CFIM is not limited to the mapping, and also analyzes dependency between the system components (elements) in order to understand how the suggested change will affect the other system components.

The CFIM 1060 verifies system constraints, while analyzing the dependency, and checks that a feedback-driven suggestion is actionable within the operational and technical limits of the target system. For example, the CFIM evaluates whether a suggested 20% increase in processing speed is achievable without exceeding thermal and power limits. This step is performed to maintain integrity of the target system and ensure that suggested enhancement of functions is theoretically correct and practically actionable. After the verification, the CFIM 1060 evaluates effects of the suggested changes. In this comprehensive evaluation, the effects of the changes on system performance, cost, and compliance with a configured measurement basis are evaluated. The CFIM uses advanced analytical tools to predict results of the suggested changes and support decision-making based on information about which optimization is to be implemented.

A result of the analysis by the CFIM 1060 is generation of a series of actionable change instructions. These instructions clearly define correction required to attain desirable goals on the basis of the feedback. These instructions include actions such as, e.g., adjusting server settings, optimizing database queries, and upgrading hardware components to achieve a specific increase in processing speed. The CFIM uses an advanced algorithm to eliminate any contradiction between competing goals and identify the change that maximizes the overall performance of the system.

These Actionable Change Instructions are transformed to specific tasks for an arrangement of the design agent orchestrator (DAO) 1080 serving as an “implementation control unit” and specialized design agents thereof. The design agent orchestrator 1060 coordinates actions of these agents and performs control such that each of the changes is precisely implemented to be aligned with the overall design strategy.

The System Update Tracker 1100 serving as an “update monitoring unit” monitors the process of optimizing the system design on the basis of a design draft 1090 received from the DAO 1080. The system update tracker 1100 provides, in real time, the system engineers with monitoring information resulting from monitoring of a situation in which the target system is updated. Tracking by the system update tracker 1100 oversees the iterative process and ensures that each design iteration progresses so as to meet the performance and functional goals of the target system.

The corrected design draft is stored in a design version database 1110 that records a history of all design iterations. This database 1110 is used to retrieve previous designs as necessary. The database 1110 provides a chronological background for design decisions made during the process of optimizing the design of the target system.

Additionally, in the system design optimization system 1, the system design vector database 1120 is provided. In the database 1120, design-related information of the target system such as, e.g., industry standards, technical publications, and verified use cases is stored. The Design Information Retriever 1130 accesses the database 1120 to extract relevant information and provide the design process of the target system with the information. This ensures that the design of the target system is constantly up-to-date and compliant with the latest standards and best practices.

As illustrated in FIG. 2, when activated (P2010), a workflow of overall processing P2000 begins with provision of the high-level feedback 1020 from the stakeholders including the system engineers (P2020). The LLM 1030 generates the technical specifications 1040 from the provided feedback 1020 (P2030). The FIM 1050 transforms these technical specifications 1040 to the structured and prioritized instructions (P2040).

The CFIM 1060 receives the instructions from the FIM 1060, and transforms the received instructions to the “Actionable Change Instructions” appropriate for being input to the DRE 1070 (P2050). In the DRE 1070, the reinforcement learning model learns on the basis of an optimal policy to evaluate potential success of different design changes to select a most appropriate “design update instruction” (P2060).

The design agent orchestrator 1080 specifies the actions of the specialized agents to implement the selected design update (P2070), and ensures a systematic and coherent application throughout the components of the target system.

Through this process, the system update tracker 1100 continuously monitors the optimization and provides the system engineers (abbreviated as SE) with detailed reports on the progress of the design updates (P2080) to ensure transparency and traceability. When the design agent orchestrator 1080 implements the changes, a loop in which the target system is iteratively improved is entered (P2110).

The updated design is evaluated again by the system engineers, and it is determined whether or not the initial requirements are satisfied (P2090, P2100). This step (P2100) confirms whether or not the system design is moving in the right direction and whether the changes are producing desirable improvements.

When the design draft 1080 does not satisfy the requirements (NO in P2100), further improvements are added (P2110). This loop is continued until the system engineers confirm that the design draft satisfies all specified requirements (YES in P2100), and a finalized design draft 1080 is eventually completed (P2120).

The process outlined in FIG. 2 embodies a dynamic feedback-driven approach to design optimization of the target system. The system design optimization system 1 integrates expertise of the stakeholders including the system engineers with advanced AI (artificial intelligence) and machine learning technology to ensure that the design of the target system is not only technically robust, but also continuously evolves so as to meet the nuanced needs and expectations of the stakeholders.

As illustrated in FIG. 1 and FIG. 2, the detailed description given above outlines a comprehensive method that exemplifies principles of latest system design optimization. This method adaptively and iteratively incorporates technical insights provided by the system engineers to effectively refine the system design and achieve design that is both functional and aligned with user needs.

Further sections explore functions of the feedback interpretation module (FIM), the contextual feedback integration mechanism (CFIM), and the design reinforcement engine (DRE), and shows an example of how the feedback is processed through the system in order to achieve the goals of the optimized system design.

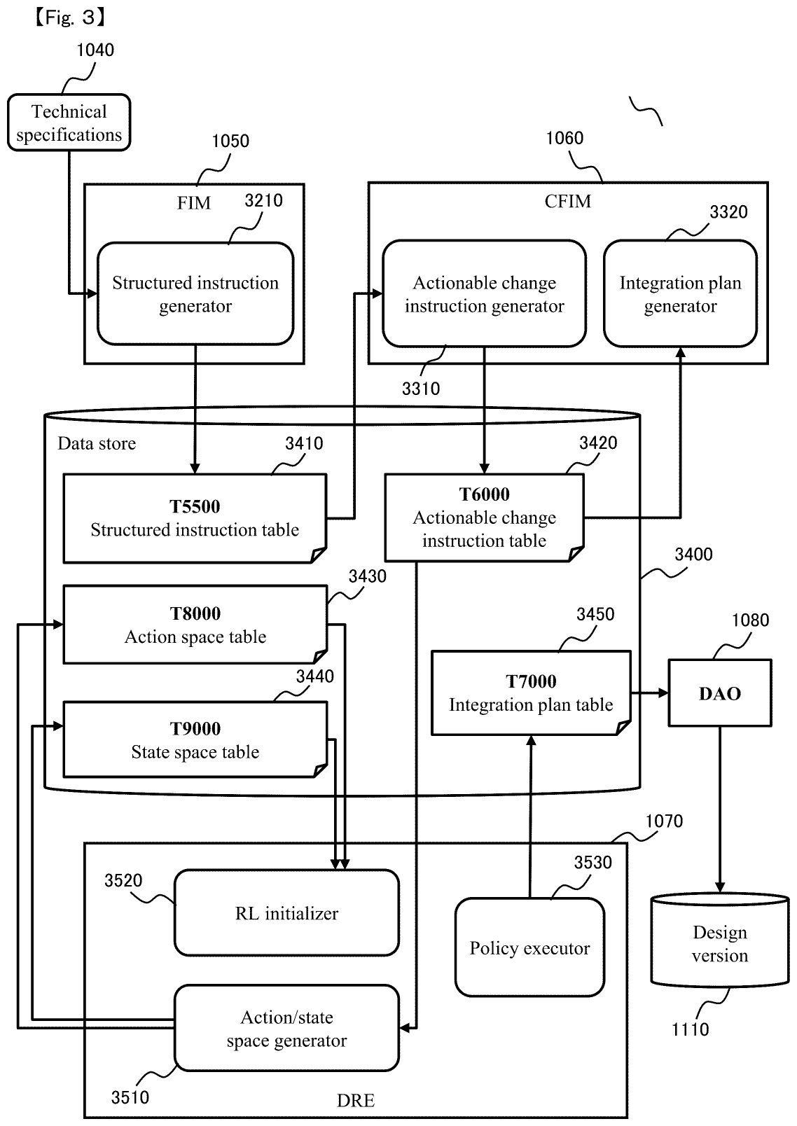

FIG. 3 illustrates an overview of a main portion 100 of the process of optimizing the design of the target system. The main portion 100 shows, in an accentuated manner, a method of transforming the technical specifications 1040 to enhanced system design by using various data structures. FIG. 3 is a schematic diagram of the workflow illustrating a flow of information via the FIM 1050, the CFIM 1060, and the DRE 1070.

The illustrated process starts with the technical specifications 1040 illustrated at upper left. The technical specifications 1040 are fundamental requirements and goals to be satisfied by the design of the target system. The technical specifications 1040 are initial inputs to the FIM 1050 to define desirable functions and performance indices of the target system.

The FIM 1050 uses a structured instruction generator 3210 to process these technical specifications 1040, breaks down complicated requirements included in the technical specifications 1040, and transforms the requirements to a series of structured instructions. This step ensures that the technical specifications 1040 are interpretable by subsequent mechanisms within the target system.

An output from the structured instruction generator 3210 is organized and recorded in a structured instruction table T5500 (3410). This table T5500 transforms the structured instructions into a consistent format to be ready for the next phase of an integration and action plan.

The CFIM 1060 receives the organized instructions from the FIM 1050 and introduces a context through an actionable change instruction generator 3310 thereof. The instructions generated in the generator 3310 are aligned with the current system design and operational constraints so as to ensure that each suggested change is both actionable and useful.

An output of the generator 3310 is documented and recorded in an actionable change instruction table T6000 (3420). The table T6000 details a specific actionable procedure required to implement the design changes. The table T6000 is used to transform high-level instructions to practical actions.

An integration plan generator 3320 produces an integration plan table T7000 (3450), and schedules and prioritizes the actionable instructions. The prioritization ensures that the target system is updated in a sequence that maximizes improvement efficiency of the target system and minimizes interruption of ongoing system operation.

The DRE 1070 functions as a decision-making core of the main portion 100, and uses an RL initializer 3520 to establish a reinforcement learning environment. The DRE 1070 includes an action/state space generator 3510. The action/state space generator 3510 determines an optimum action sequence for the system design improved through the learning by the DRE 1070.

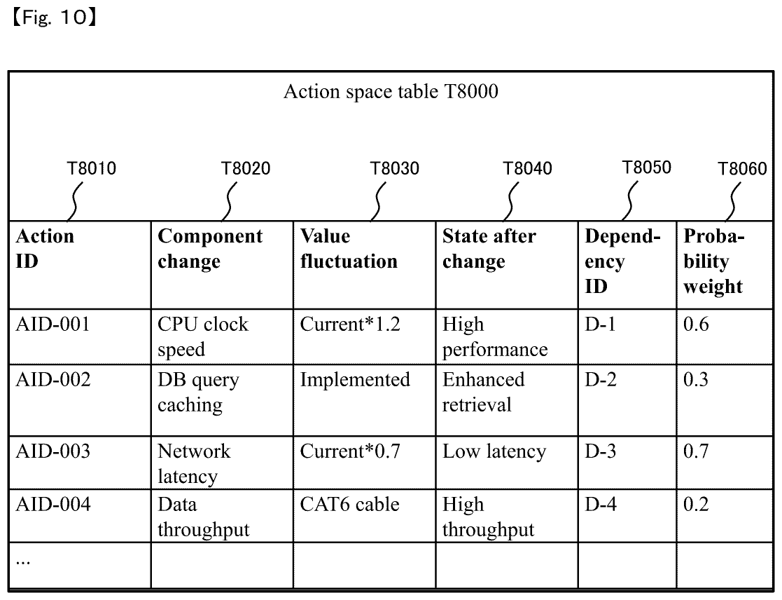

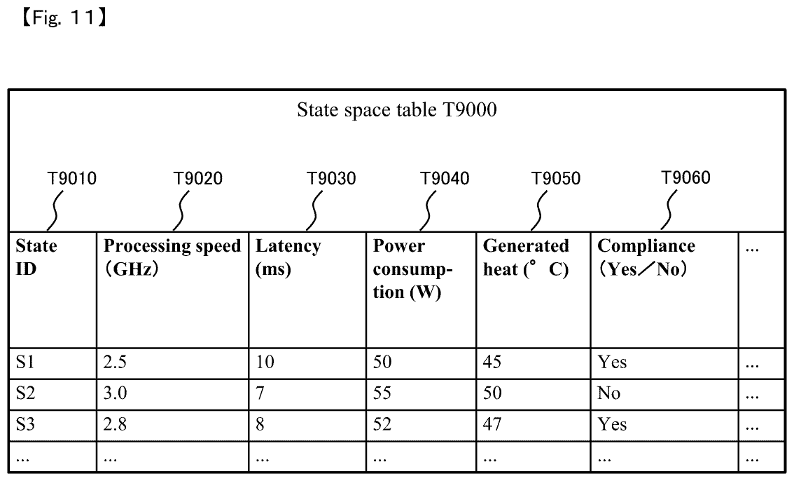

An action space table T8000 (3430) and a state space table T9000 (3440) are generated by the DRE 1070. The table T8000 illustrated in FIG. 10 represents a range of possible actions. The table T9000 illustrated in FIG. 11 represents various system states. These tables T8000 and T9000 are used by the reinforcement learning algorithm to specify a possibility of a design update that optimizes the system performance.

A policy executor 3530 applies the learned policy to generate “Design Update Instructions”. These generated instructions are integrated into the design of the target system through the design version database 1110 that records each iteration of the system design.

The design agent orchestrator (DAO) 1080 manages the application of the “Design Update Instructions”, and makes adjustment such that the changes related to the target system are implemented according to the integration plan table T7000, while coordinating with the various design agents.

A data store 3400 functions as a central repository for all information generated through the optimization process, from the structured instructions to a final design version. The data store 3400 is used to maintain data integrity and support continuous learning and adaptation by the main portion 100.

### FIM Description

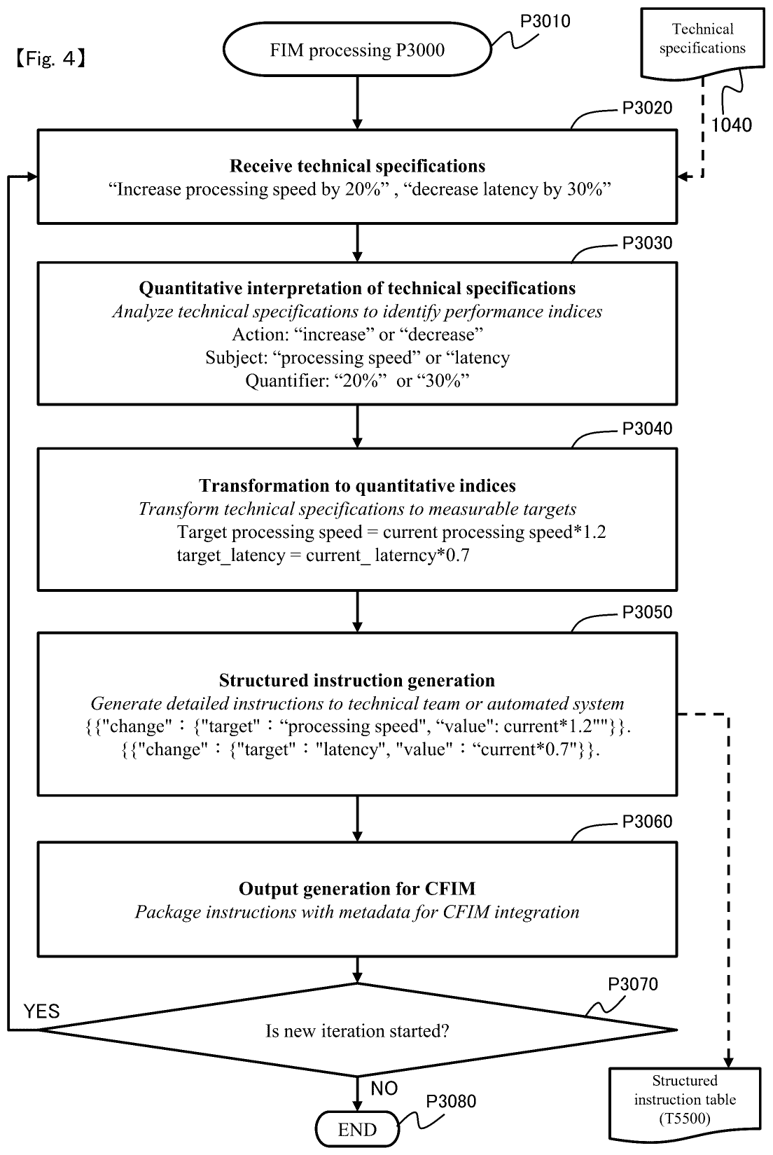

FIG. 4 illustrates details of processing (P3000) to be performed by the feedback interpretation module (FIM) 1050. When activated (P3010), the processing P3000 to be performed by the FIM 1050 receives (P3030) and interprets (P3030) the technical specifications 1040 obtained from the high-level feedback to transform the technical specifications 1040 to structured actionable and quantifiable instructions.

This description includes examination of mathematical equations and formulas that use an example of technical specifications such as “increase processing speed by 20%” and “decrease latency by 30%” (P3020) to clarify a transformation process in the FIM and facilitate this transformation.

### [P3030] Quantitative Interpretation of Technical Specifications:

The FIM 1050 starts a task by engaging in quantitative interpretation of the technical specifications 1040. The step P3030 includes analyzing a language used in the technical specifications to identify major performance indices and desirable changes thereof. The interpretation step is based on a language processing algorithm capable of discerning technical terms and extracting specific quantitative goals.

For the given example, the FIM has identified two major commands:
(1) An increase in “processing speed” by a percentage amount (20%).
Action: “increase”
Subject: “processing speed”
Unit: “by 20%”
(2) A decrease in “latency” by a given percentage amount (30%).
Action: “decrease”
Title: “latency”
Unit: “up to 30%”

These commands are subjected to mathematical formalization to allow the target system to understand and process the commands in terms of mathematical operations.

### [P3040] Quantifiable Metric Conversion

The FIM 1050 moves to a quantifiable metric conversion step P3040 to convert qualitative instructions to measurable metrics. This step P3040 uses mathematical formulas to accurately express the intended changes into numerical values.

In a case of “increasing processing speed by 20%”, the conversion can be represented by an expression:

$$Pt target = P current \times 1.2 \qquad ( Expression 1 )$$

Likewise, in a case of “decreasing latency by 30%”, the current latency (L_current) is used as a baseline to calculate a new latency goal (L_target):

$$L target = L current \times 0.7 \qquad ( Expression 2 )$$

These equations serve as a basis for subsequent transformation of the specifications to structured instructions.

### [P3050] Structured Instruction Generation:

Following the metric conversion, the FIM 1050 uses a mathematical result to generate structured instructions. This step P3050 transforms the mathematical formulation into a standardized format to clearly define a nature of the change, the target metric, and a precise value with which the metric is to be changed.

Using results of Expressions 1 and 2, the structured instructions are represented as follows:

$$Instruction A ( Command A , the same applies hereinafter . ) \{ {\{ {}^{‵} {change}^{′} : \{ {}^{‵} target}^{′} : {}^{‵} {processing\_speed}^{′} , {}^{‵} {value}^{′} : {}^{‵} current value * {1.2}^{′} \} \} \qquad ( Expression 3 )$$

$$Instruction B \{ \{ {}^{‵} {change}^{′} : \{ {}^{‵} {target}^{′} : {}^{‵} {latency}^{′} , {}^{‵} {value}^{′} : {}^{‵} current value * {0.7}^{′} \} \} \qquad ( Expression 4 )$$

These instructions are obtained by putting the technical specifications in a format easily readable by machines, and clearly describe the required changes in detail. Table T5500 is updated so as to maintain these structured instructions.

### [P3060] Output Generation for CFIM:

A final step in the process of the FIM 1050 is preparing an output for the CFIM. The FIM packs the structured commands into an output set in the table T5500 designed to be used by the CFIM. This output is a package carefully prepared not only to merely send data, but also to meet the work needs of the CFIM, and it is checked that the commands can be directly used in the process of the CFIM.

The output to the CFIM includes the structured commands (such as the instruction A and instruction B mentioned above) and additional details describing where the command came from, importance thereof, and relevance thereof with other commands. By this detailed output, it is allowed to confirm that the CFIM has everything that is needed to effectively advance the system design optimization process.

In step P3070, when the system engineers agree with the design version, and do not perform any improvement (NO in P3070), the FIM process stops (P3080). Otherwise (YES in P3070), the process uses new technical specifications produced from the latest feedback to advance to a new round (P3020).

### CFIM Description

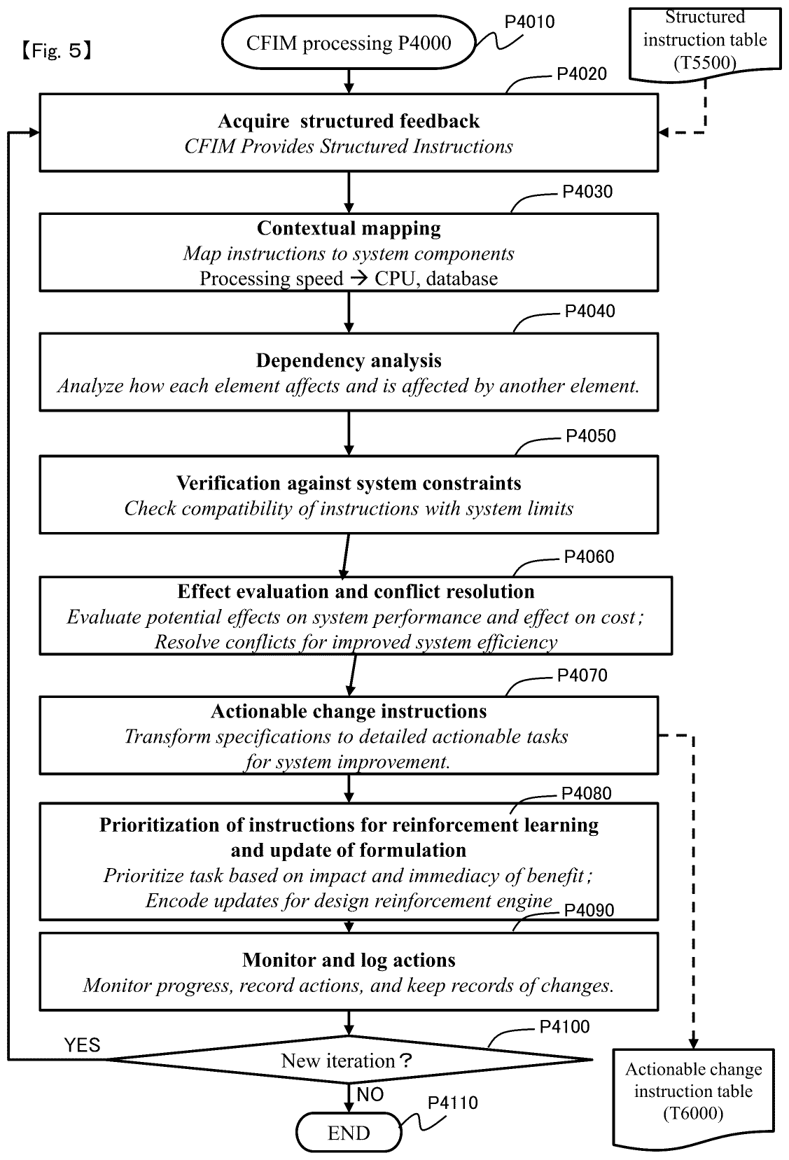

FIG. 5 is a flow chart showing processing P4000 to be performed by the CFIM 1060. The CFIM 1060 transforms the technical specifications 1040 from the FIM 1050 to actionable changes in the system design. This description uses, as an example, structured instructions aiming at increasing a processing speed and reducing latency in the target system to describe steps related to the CFIM.

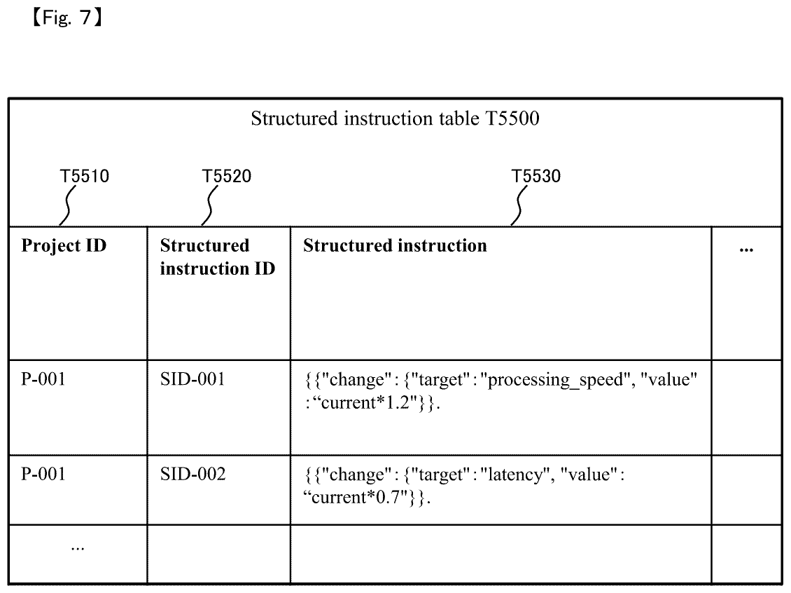

The CFIM functions as a center point where the feedback from the FIM is given a context within the existing system design. The CFIM uses the system design vector database 1120 to refer to previous design iterations in order to guide processes thereof and determinations. The CFIM not only receives instructions, but also actively processes and analyzes the structured feedback, and changes the structured feedback to an actionable plan that meets the operational limits and performance goals of the target system. The processing P4000 of the CFIM begins by being activated (P4010) and retrieving the structured instructions from the table T5500 illustrated in FIG. 7 (P4020).

### [P4030] Contextual Mapping:

A first step of the CFIM 1060 is contextual mapping in which the structured instructions are aligned with specific components of the system design. The CFIM evaluates the instructions:

$$\{ \{ {{}^{‵} {change}^{′} : \{ {}^{‵} target}^{′} : {}^{‵} {processing\_speed}^{′} , {}^{‵} {value}^{′} : {}^{‵} current value * {1.2}^{′} \} \} \qquad ( Expression 5 )$$

$$\{ \{ {}^{‵} {change}^{′} : \{ {}^{‵} {target}^{′} : {}^{‵} {latency}^{′} , {}^{‵} {value}^{′} : {}^{‵} current value * {0.7}^{′} \} \} \} \qquad ( Expression 6 )$$

The CFIM produces and maps the foregoing expressions to the relevant system components. For example, an instruction to increase the “processing speed” is mapped to an algorithmic process that may affect the CPU, a database configuration, or a computational speed of the target system. Conversely, an instruction to decrease the “latency” is associated with network hardware, a communication protocol, or a data processing method that may affect responsiveness of the target system.

### [P4040] Dependency Analysis:

When mapping the change instructions to the relevant system components, the CFIM 1060 performs dependency analysis. This analysis uncovers a complicated interdependent network in an architecture of the target system, and shows how each component affects and is affected by another component.

In response to a command to “increase processing speed by 20%”, the dependency analysis produces a graph representing the processing speed as nodes, and identifies all other system nodes that either contribute to or are affected by an index thereof.

The CFIM acknowledges that the processing speed is directly linked to CPU performance affected by factors such as a clock rate, a core count, thermal design power (TDP), and efficiency of a cooling system. The CFIM also considers secondary effects, such as increased power consumption that places a heavier load on a power supply unit (PSU).

Likewise, an instruction to “decrease latency by 30%” leads the CFIM to map out network components such as a router, a switch, and an interface and protocols that manage data transmission. The analysis examines how the decreased latency affects a network throughput, data packet integrity, and performance of a real-time application.

The dependency graph is dynamic, changes with each design iteration, and reflects evolution of the target system and the components thereof. The dependency graph helps visualize a bottleneck or failure points that may be caused by the suggested changes, and thus enables proactive mitigation strategies.

### [P4050] Verification Against System Constraints:

After understanding the dependencies, the CFIM verifies the suggested changes against the existing functions and limitations of the target system. This verification uses a combination of knowledge of the target system and previous data to determine whether the changes can be implemented without adversely affecting the target system. For example, when the processing speed of the target system is to be increased, the CFIM uses thermal simulation software to estimate extra heat generated when the speed of the CPU is increased. The estimated value is checked against ratings of the thermal design power (TDP) of the CPU and a capacity of the cooling system. Likewise, for power consumption also, the CFIM compares an expected additional power load to a rated output of the power supply unit (PSU). For the decrease of the latency, the CFIM examines network infrastructure to make sure that higher-speed data transmission can be processed without increasing errors or congestion. The CFIM checks whether the current hardware can meet lower-latency needs or whether updates or upgrades are necessary.

### [P4060] Effect Evaluation and Conflict Resolution:

After having succeeded in verification, the CFIM performs impact assessment to evaluate how the suggested changes affect the performance of the overall system. The CFIM uses predictive modeling to estimate effects on a task completion time, energy efficiency, potential thermal throttling, and the like when the processing speed is increased by 20%. When the latency is decreased by 30%, attention is focused on an expected responsiveness improvement and effects on network operation. Conflict resolution is an important portion of the impact assessment. The CFIM uses an algorithm to solve conflicts between competing goals. For example, when higher-speed processing causes excessive heat generation, the CFIM may suggest redistributing computational loads or improving cooling to reach a desired speed without overheating. This oftentimes involves making trade-offs between different performance aspects to find a solution that balances improvements with minimal disadvantages. Through steps such as dependency analysis, verification, and effect evaluation, the CFIM confirms that the suggested changes are technically sound and optimized for the performance and sustainability of the overall system. These steps ensure that each design change benefits the system development, stays within operational limits, and is aligned with the goals based on the feedback from the stakeholders.

### [P4070] Actionable Change Instructions:

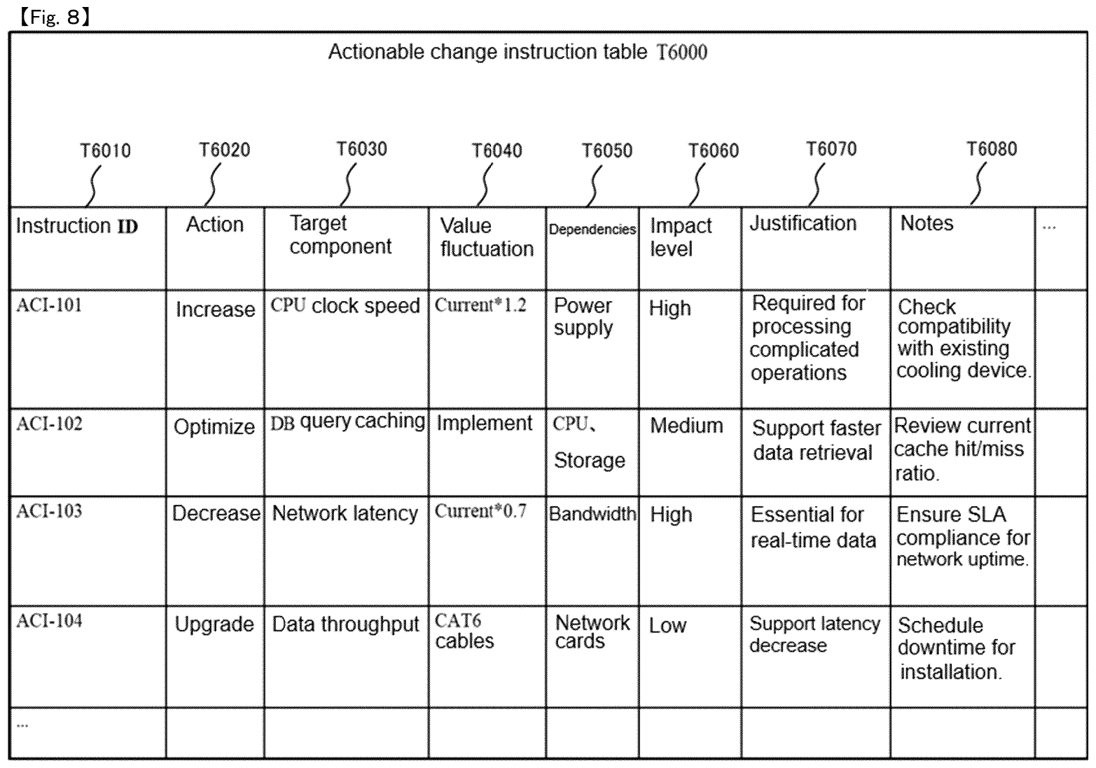

After completing the effect evaluation and resolving the conflicts, the CFIM organizes the specifications into “Actionable Change Instructions”. These instructions specify the changes needed for the system design in accordance with specific components identified earlier. The table T6000 lists specific tasks, goals thereof, extents of the changes, and reasons for the individual instructions. For example, in the table T6000 illustrated in FIG. 8, in an instruction ID “ACI-101”, it is recorded that expected performance cannot be obtained unless the clock speed of the CPU is increased to 1.2 times the current clock speed.

### [P4080] Prioritization of Instructions and Update of Formulation in Reinforcement Learning:

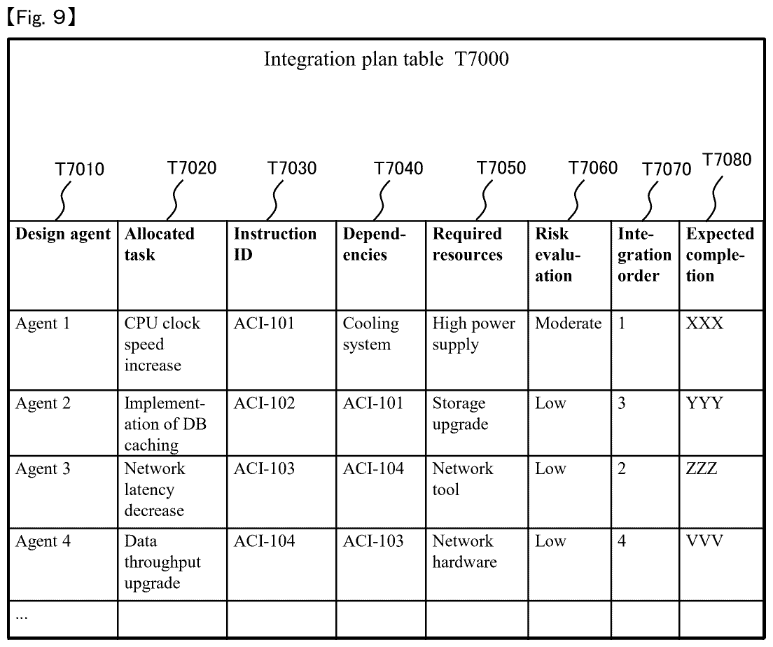

The CFIM then prioritizes the instructions on the basis of impact and urgency thereof. The prioritization helps determine the order of implementation. The prioritization is important when resources are limited or when some changes depend on being implemented earlier than the others. The priority table T7000 illustrated in FIG. 9 ranks each instruction by importance thereof. For example, the “ACI-101” may be given a top priority due to a significant effect exerted thereby on major functions of the target system. Meanwhile, an “ACI-104”, which is a secondary upgrade for improving the latency, may have a lower priority.

Thus, the CFIM 1060 functions as a central control tower in the optimization process of the system design, and processes planning, prioritization, and communication to ensure that each step is an intentional move toward an optimized system design.

### DRE Description

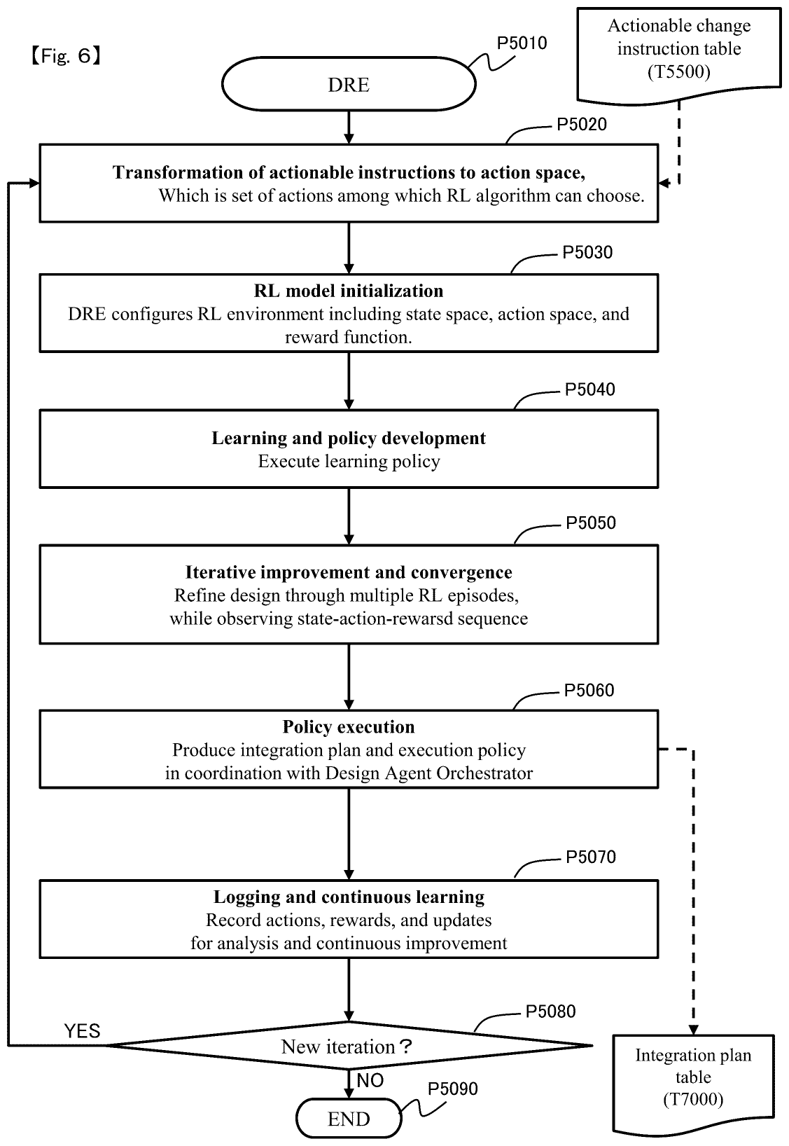

FIG. 6 is a flow chart illustrating processing P5000 to be performed by the DRE 1070. The DRE is a final stage in the system design optimization process, and transforms the actionable instructions from the CFIM 1060 to actual changes in the system design. When activated (P5010), the DRE 1070 uses an advanced reinforcement learning (RL) component that employs an advanced algorithm to identify the most effective action to optimize the system design.

### [P5020] Transforming Actionable Instructions to Action Space:

The DRE begins by transforming the actionable change instruction table to an action space including potential actions among which the RL algorithm can choose. This action space is defined by the available actions and also by states that the system may enter subsequently to these actions. In this step, table data is transformed to a format understandable by the RL model, such as vectors and matrices. FIG. 8 is an example of the actionable change instruction table T6000. Each row in the table T6000 represents, e.g., an action, the component targeted for the change, a new value to which the change is to be made, an expected state of the system after the change, and a probability weight that reflects a possibility that the action is a best choice.

For example, taking the action (ACI-101) to increase the clock speed of the CPU is encapsulated as follows:

$$ActionCPU\_Increase = \{ {}^{‵} {component}^{′} : {}^{‵} {CPU}^{′} , {}^{‵} {operation}^{′} : {}^{‵} {increase\_speed}^{′} , {}^{‵} {factor}^{′} : 1.2 \} \qquad ( Expression 7 )$$

This action specifies the component (CPU), the operation (increase speed), and the factor by which the speed is to be increased (1.2 times the current speed). Accordingly, the action space is a collection of such actions for all the components that need to be changed according to the instructions from the CFIM. The DRE ensures that each action is encoded with sufficient metadata to reflect the urgency, dependencies, and expected effects of the instructions presumed from the analysis by the CFIM.

### [P5030] Reinforcement Learning Model Initialization

The DRE begins by initializing the RL model to configure the state space, the action space, and the reward function. The state space represents all possible settings of the system in a higher dimension. As previously defined, the action space includes all the actions that can be executed by the model, and each of the actions is provided with a probability weight indicating the possibility of being an optimal choice. The reward function is produced to evaluate effectiveness of each of the actions executed by the model.

Initially, the RL model starts in a neutral state, and begins to explore the action space without any background knowledge. When executing any action, the RL model receives feedback in the form of a reward or penalty, uses the feedback to refine a strategy and enhance a decision-making ability.

Simultaneously with encoding of the actions, the DRE updates the state space to represent the potential states of the system after the actions are executed. In this updating process, the latest system data, including performance indices and constraints, is incorporated such that the state space precisely reflects the current state of the system design.

For example, in a scenario issuing instructions to increase the processing speed and decrease the latency, the state space includes dimensions for the processing speed, the latency, the power consumption, a thermal output, and other appropriate parameters. FIG. 11 illustrates the illustrative table T9000 for the state space. Each row in the table T9000 describes a specific state that the system may enter, together with values corresponding to the individual dimensions. Additionally, a “Compliance” column functions as a binary index to indicate whether a state thereof meets all system constraints and requirements.

The Reward Function is continuously improved according to the updated system goals and performance benchmarks. The DRE corrects the reward function to give higher rewards when essential performance improvements are achieved or when important system constraints, such as limits on power consumption and thermal output, are complied with.

An algorithm for the reward function in the current scenario is configured as follows:
(1) Initialize the reward to zero.
(2) For each action, calculate changes in processing speed and latency.
(3) When the processing speed has increased by 20%, add a significant positive value to the reward.
(4) When the latency has decreased by 30%, add a significant positive value to the reward.
(5) When the power consumption or thermal output exceeds the system constraint, subtract a significant value from the reward.
(6) When the system remains compliant with all design specifications after the action, add an appropriate positive value to the reward.
(7) The reward for each action is a sum of the values in the foregoing (3) to (6).

The reward function can be represented by the following formula:

$$R ( a ) = w 1 \cdot Δ PS ( a ) + w 2 \cdot Δ L ( a ) - w 3 \cdot Δ PC ( a ) - w 4 \cdot Δ TO ( a ) + w 5 \cdot C ( a ) \qquad ( Expression 8 )$$

where:
R(a) is the reward for an action ‘a’,
ΔPS(a) is the change in processing speed due to the action ‘a’,
ΔL(a) is the change in latency due to the action ‘a’,
ΔPC(a) is the change in power consumption due to the action ‘a’,
ΔTO(a) is the change in thermal output due to the following factor
action ‘a’,
C(a) is a binary value indicating compliance with design specifications after the action a,
w1, w2, w3, w4, and w5 are the weights assigned to individual terms and reflecting relative importances in the overall design goals

For example, the reward function adds a high positive reward for an action that achieves or surpasses the target 20% increase in processing speed. When the action results in a processing speed increase of exactly 20%, ΔPS(a) may be set to 1 (fully achieved goal), and w1 may have a high positive numerical value reflecting the importance of this index. When the goal is exceeded, ΔPS(a) has a numerical value slightly larger than 1, and additional reward resulting from the exceeded goal is obtained. Conversely, when the action cannot achieve the goal, ΔPS(a) becomes less than 1 to reduce the reward.

For the decrease of the latency also, a similar approach is taken. When exactly a 30% reduction is achieved, ΔL(a) is configured to 1, and w2 becomes another high positive number. When the latency reduction goal is overachieved, a value of ΔL(a) becomes larger than 1 while, when the latency reduction goal is not achieved, the value becomes less than 1.

An action that results in the power consumption or thermal output exceeding the operational constraints of the system negatively affects the reward. For example, when a certain action increases the power consumption beyond the power supply ability of the system, ΔPC(a) becomes positive, and w3 is a negative weight, and accordingly the overall reward is decreased thereby. Likewise, when the thermal output exceeds the ability of the cooling system, ΔTO(a) becomes positive, and w4 (which is also negative) reduces the reward.

Finally, compliance with design specifications after each action is critically important. When the action maintains or improves the compliance, C(a) is configured to 1, and w5, which is a positive weight, increases the reward. When the compliance is impaired, C(a) becomes 0, and there is no additional reward.

The reward function functions as a comprehensive index for measuring effectiveness of the action for guiding the target system toward a desirable state, and balances improvements in performance metrics with the need to stay compliant with the operational constraints and the design specifications. This function serves as a center in a learning process of the DRE, and guides the RL algorithm toward optimal decision-making that is aligned with the comprehensive design goals of the system.

### [P5040] Learning and Policy Development

The description returns to FIG. 6. The DRE 1070 employs a policy-based reinforcement learning approach, and the policy defines the action of the agent at a certain time point. The policy is a function that aims at maximizing cumulative reward and associates the states with the actions.

In the learning process, the DRE executes actions, observes the rewards, and accordingly adjusts the policy. In the learning and policy development phase of the DRE, the engine undertakes an important task of developing the policy. The policy is a strategy that indicates the best action to take in a given state and maximizes the cumulative reward with a lapse of time. In the current scenario which requires a balance between an ability to handle the complicated and high-dimensional action space and state space with the need for stability and reliability in the learning process, Proximal Policy Optimization (PPO) is selected as the optimal algorithm.

The PPO algorithm includes the following steps:

(1) Collecting Data by Interaction with Environment:

The DRE simulates a system design environment or interacts with an actual environment when the actual environment is safe enough, and executes actions on the basis of the current policy to collect data on the state, the action, the reward, and a next state.

### (2) Estimation Advantage Function:

The algorithm calculates an advantage function, and measures how much better it is to take a specific action compared to an average action in that state. This is typically performed by using Generalized Advantage Estimation (GAE).

### (3) Optimize Surrogate Objective:

A PPO algorithm optimizes a surrogate objective function that rewards the policy of taking a more advantageous action, while keeping policy updates within a trust region to avoid excessively large policy updates.

### (4) Using Clipped Probability Ratio:

The PPO introduces a clipping mechanism to the objective function to prevent large policy updates. This is carried out by clipping a probability ratio between the new and old policies and keeping the probability ratio within a range of values close to 1.

### (5) Update Policy Using Stochastic Gradient Ascent:

The policy is updated using stochastic gradient ascent to maximize the clipped surrogate objective function. This step is repeated a plurality of times by using the same batch of collected data, and accordingly the PPO has a higher sample efficiency.

### (6) Iterating Process:

The foregoing (1) through (5) are iterated a plurality of times. Each iteration further refines the policy, and performance thereof is improved with a lapse of time.

### (7) Policy Evaluation:

Periodically, the updated policy is evaluated in the system design environment, it is confirmed that the performance thereof is actually improved, and convergence is monitored.

An example of update rules for the PPO algorithm can be written as follows:

For each iteration:
a. Collect a set of tuples (st, at, rt, st+1), where st is the current state, at is the action taken, rt is the received reward, and st+1 is the next state.
b. Calculate an estimated advantage value At by using the GAE.
c. Optimize the surrogate objective:

$$L\_CLIP ( θ ) = Et [ min ( rt ( θ ) At , clip ( rt ( θ ) , 1 - e , 1 + e ) At ) ] \qquad ( Expression 9 )$$

where rt(θ), =[πθ(atIst)]/[πθold(atIst)] is a probability ratio, θ are policy parameters, π denotes the policy, and e is a hyperparameter that defines a clipping range.
d. Update the policy parameters θ by ascending the gradient (=∇θLCLIP(θ)).
e. Verify performance of the updated policy, and iterate the process until the process is converged.

The strength of the PPO algorithm lies in balance between exploration (trying new actions) and exploitation (improving the policy to increase the rewards). By implementing the clipping mechanism, the PPO maintains a steady and reliable convergence operation. This is useful in system design optimization where drastic changes can have significant effects.

### [P5050] Iterative Refinement and Convergence

The DRE iterates learning and simulation a large number of times to refine the policy with each cycle. The convergence is achieved when there is no significant change in policy even with further learning, and indicates that the model has identified an optimal or near-optimal set of actions.

This phase includes a sequence of cycles in which the DRE interacts with a system environment, implements the current policy, observes a result, and then finely adjusts the policy on the basis of the received feedback. The iterative improvement process includes the following steps:
a. Apply Policy: The DRE applies the current policy to the system design environment. This includes executing a series of actions as indicated by the policy across various states of the system.
b. Observe Results: The DRE observes the effect of each of the actions in terms of changes in system performance, user experience, and other relevant measurement criteria. Such monitoring is important for the DRE to measure the effect of the action thereof.
c. Collect Rewards: After executing the actions, the DRE collects the rewards on the basis of the reward function defined in advance. These rewards reflect desirability of the executed actions.
d. Policy Update: Using the feedback from the rewards, the DRE updates the policy so as to encourage the actions that resulted in positive results and to discourage the actions that were less effective.
e. Evaluate Convergence: The DRE evaluates whether or not the policy is stabilized. This evaluation is performed on the basis of how much the actions and rewards have fluctuated with time. When there is a still significant fluctuation after each update, the policy has not been converged yet.
f. Iterate: A cycle is iterated in which the DRE implements the corrected policy, observes a result, collects the rewards, updates the policy, and evaluates the convergence again.

The convergence is recognized when the policy of the DRE is stabilized over the iterations, and the adjustment of the system design consistently produces results that effectively meet the goals and constraints of the system.

### [P5060] Policy Execution

Once the policy of the DRE is stabilized, the engine applies the selected actions to the system to thereby proceed to implement the policy. This implementation is coordinated with the design agent orchestrator 1080 and various design agents who are in charge of making actual changes to the system.

In the execution of the policy, the “Design Update Instructions” generated at this stage are implemented. These instructions are detailed instructions that specify precise changes needed for the system design to improve the performance, stability, or compliance with the requirements. A process of producing the “Design Update Instructions” includes the following:
Transforming the actions recommended from the policy to specific design changes.
Verifying these changes against the current state and constraints of the system.
Formatting the instructions clearly and precisely so as to allow design agents to effectively implement the instructions.

The integration plan table T7000 is produced to list up the “Design Update Instructions” and schedule the implementation thereof. This table T7000 allows the individual changes to be implemented in a logical sequence and allows work coordination between the various design agents.

The integration plan table T7000 is transmitted to the design agent orchestrator 1080, which manages the implementation of the “Design Update Instructions”. The orchestrator 1080 coordinates with specialized design agents, and each of the agents takes on a task of implementing specific changes according to the integration plan. This coordination allows all the agents to smoothly work together, and integrity of the system is maintained throughout the entire update process.

The table T7000 functions as the integration plan table. To each of the design agents, a task is allocated, and an instruction ID corresponding thereto and a timeline to completion are allocated from the prioritization table. This configuration allows all the tasks to be efficiently and effectively completed.

### [P5070] Logging and Continuous Learning

The DRE 1070 includes a comprehensive logging system that records each determination, action, and result in the design optimization process. This logging allows the system engineers to review and understand a DRE decision-making process and can ensure transparency.

Continuous learning is an important portion of the DRE operation. The engine reviews the logs from each iteration to learn from successes and identify regions to be improved. A result of this analysis is reflected on a DRE leaning algorithm, and the engine can adjust and improve the policy on the basis of new data or evolving system requirements.

Additionally, the continuous learning process updates the state space and the reward function in consideration of new constraints or goals. As the system develops, understanding of the system by the DRE is also deepened, and the optimization process is reliably synchronized with the current and future needs of the system.

### Design Agent Orchestrator

Following activities inside the DRE, optimization of the system design advances through several important stages led by the design agent orchestrator 1080. In this phase, a design draft is produced, and the review of the design draft and decision-making by the system engineers is performed.

The design agent orchestrator 1080 functions as the central control tower for implementing the policy developed and refined by the DRE. The orchestrator 1080 coordinates among the actions of the various design agents who execute specific tasks related to updates of the system design. The orchestrator 1080 ensures that each design agent understands the role thereof and executes the task allocated thereto according to comprehensive design goals.

Major functions of the design agent orchestrator 108 are as follows:
Task Distribution: Assigning specific tasks to the design agents according to an action plan derived from the DRE policy.
Synchronization: Making sure that, particularly when a certain task depends on completion of another task, the tasks are executed in a correct order.
Monitoring Execution: Overseeing the execution of the tasks to ensure that all the actions adhere to the planned strategies and timelines.

### Production of Design Draft

Once the design agent orchestrator 1080 has coordinated the implementation of all necessary design changes, system design in a new version, referred to as the design draft 1090, is produced. This draft 1090 reflects the current state of the target system after the implementation of optimized changes, and indicates an iterative learning and decision-making process.

The production of the design draft includes the following:
Integration: Merging all individual changes into cohesive system design.
Verification: Checking that the design draft meets all specified requirements and functions as expected.
Documentation: Recording the implemented changes, including reasons behind the changes and expected effects thereof on the system performance.

### System Update Tracker

The system update tracker 1100 is a tool for recording and analyzing progression of the system design throughout the optimization process. The system update tracker 1100 records each executed action, a result thereof, and effects thereof on the performance of the system and compliance with requirements.

Functions of the system update tracker are as follows:
Recording of Changes: Maintaining a detailed record of all design changes implemented during the optimization process.
Performance Tracking: Monitoring major performance indices to evaluate effects of design changes.
Historical Analysis: Providing insights into the evolution of the system design to support future decision-making processes.

Upon completion of a design draft 1090, as illustrated in FIG. 1, the design draft 1090 is presented to the stakeholders 1000 including the system engineers, and a comprehensive evaluation is performed. In this evaluation, the design draft is checked against initial requirements, performance criteria, and expectations of the stakeholders. The stakeholders, including the system engineers, critically examine the design in order to confirm that the design meets the desired specifications and fulfills the intended goals of the target system.

### Determination of Further Feedback or Approval of Design Draft

On the basis of the evaluation, the system engineers make an important determination:

Further Feedback: When the design draft 1090 does not fully meet the requirements or when there is a possibility of further optimization, the stakeholders including the system engineers provide additional feedback to start another cycle of improvement.
Approval: When it is determined that the design draft meets all criteria and is satisfactory, the stakeholders, including the system engineers, approve the design, which results in a successful end of the design optimization process.

As described above, the present disclosure includes the comprehensive system for optimizing the system design through an iterative feedback information process. By integrating the reinforcement learning with the expertise of the system engineers, the system design optimization system 1 in the present disclosure can continue to efficiently and appropriately optimize the design of the target system.

In the approach in the present disclosure, the PPO algorithm of the DRE 1070 is utilized to iteratively improve the design of the target system to meet or exceed the performance criteria and the expectations of the stakeholders. The design agent orchestrator 1080 plays an extremely important role in transforming these refined policies to the actionable changes, and produces the optimized design draft. This process is tracked by the system update tracker 1100, provides valuable data for the evaluation by the system engineers, and eventually determines the approval of the design or a need for further improvement.

Thus, the system design optimization system 1 in the present disclosure provides a dynamic and adaptive framework resulting from the integration of the expertise of the stakeholders, including the system engineers, with artificial intelligence. The present disclosure is not limited to the embodiments described above as is, and can deform and embody components within the scope not departing from the gist thereof or appropriately combine and implement the plurality of components disclosed in the foregoing embodiments in an implementation stage.

What is claimed is:

1. A system design optimization system that optimizes design of a target system,
the system design optimization system being configured to:
acquire feedback related to an improvement of the target system from a stakeholder of the target system;
interpret the acquired feedback to apply the feedback to the target system;
generate, from a result of the interpretation, an instruction set to be given to the target system;
provide the stakeholder with an implementation status of the instruction set; and
acquire the feedback related to the improvement of the target system until the stakeholder approves.

2. The system design optimization system according to claim 1, comprising:
a feedback reception unit configured to receive the feedback from the stakeholder related to the target system;
a large-scale language model unit trained to generate technical specifications from information input thereto, the large-scale language model unit being configured to generate the technical specifications from the feedback received by the feedback reception unit;
a feedback interpretation unit configured to interpret the technical specifications generated by the large-scale language model unit;
a contextual feedback integration unit configured to generate, on the basis of a result of the interpretation by the feedback interpretation unit, a structured actionable instruction set indicating, among a plurality of elements included in the target system, an element to be changed and details of the change;
a design reinforcement unit configured to generate, from the instruction set generated by the contextual feedback integration unit, a design update instruction to update the design of the target system;
an implementation control unit configured to send, on the basis of the design update instruction generated by the design reinforcement unit, the design update instruction to a change execution unit configured to implement the design update instruction in the target system and drive the change execution unit; and
an update monitoring unit configured to monitor a state of the implementation by the implementation control unit and provide the stakeholder with monitoring information including a monitoring result.

3. The system design optimization system according to claim 2, wherein the feedback reception unit is configured to receive new feedback from the stakeholder who has received the monitoring information.

4. The system design optimization system according to claim 3, wherein the contextual feedback integration unit configures a priority of implementation to each of instructions included in the structured actionable instruction set.

5. The system design optimization system according to claim 4, wherein the contextual feedback integration unit is configured to generate the instruction set on the basis of a dependency relationship between the element to be changed among the elements and another element among the elements.

6. The system design optimization system according to claim 5, wherein the contextual feedback integration unit is configured to generate the instruction set so as to meet a system constraint configured to the target system.

7. The system design optimization system according to claim 6, wherein the design reinforcement unit includes a reinforcement learning unit configured to learn on the basis of the received feedback, and the design update instruction is generated by the reinforcement learning unit.

8. The system design optimization system according to claim 7, wherein the design reinforcement unit is configured to cause the reinforcement learning unit to iteratively generate the design update instruction on the basis of a defined state space, a defined action space, and a defined reward function.

9. The system design optimization system according to claim 8, wherein the state space indicates all settings that are possible in the target system, the action space includes all actions that can be executed by the target model and that have respective probability weights each indicating a possibility of being an optimal choice, and the reward function is to evaluate effectiveness of each of the actions to be executed by the target model.

10. A system design optimization method for causing a computer to optimize design of a target system, the method comprising, by the computer:
receiving feedback related to an improvement of the target system from a stakeholder of the target system;
using a large-scale language model unit trained to generate technical specifications from information input thereto and generating the technical specifications from the received feedback;
interpreting the generated technical specifications;
generating, on the basis of a result of the interpretation, a structured actionable instruction set indicating an element to be changed among a plurality of elements included in the target system and details of the change;
generating, from the generated instruction set, a design update instruction to update the design of the target system;
causing, on the basis of the generated design update instruction, the target system to implement the design update instruction; and
monitoring a status of the implementation and providing the stakeholder with monitoring information including a result of the monitoring.

11. The system design optimization method according to claim 10, wherein the computer is caused to receive new feedback from the stakeholder who has received the monitoring information.

12. The system design optimization method according to claim 11, wherein the computer is caused to configure a priority of the implementation to each of instructions included in the instruction set.

13. The system design optimization method according to claim 12, wherein the computer is caused to generate the instruction set on the basis of a dependency relationship between the element to be changed among the elements and another element among the elements.

14. The system design optimization method according to claim 13, wherein the computer is caused to generate the instruction set so as to meet a system constraint configured to the target system.

15. The system design optimization method according to claim 14, wherein the computer is caused to use a reinforcement learning unit configured to learn on the basis of the received feedback to generate the design update instruction.
